(19) United States
(12) Patent Application Publication
(10) Pub. No.: US 2020/0318704 A1
(43) Pub. Date: Oct. 8, 2020

(54) TWO-PIECES CAGE FOR FRICTION RING TO BE USED IN FRICTION DAMPERS FOR WASHING MACHINES

(71) Applicant: C.I.M.A. Compagnia Italiana Molle Acciaio S.p.A., Busnago(MB) (IT)

(72) Inventor: Andrea Franco, Busnago (MB) (IT)

(73) Assignee: C.I.M.A. Compagnia Italiana Molle Acciaio S.p.A., Busnago (MB) (IT)

(21) Appl. No.: 16/303,662

(22) PCT Filed: Jun. 5, 2017
(86) PCT No.: PCT/IB2017/053301

§ 371 Date: Nov. 21, 2018

(30) Foreign Application Priority Data
Jun. 10, 2016 (IT) 102016000059852

(51) Int. Cl. F16F 7/09; D06F 37/20

(52) U.S. Cl. CPC F16F 7/09; F16F 9/3235; D06F 37/20

(57) ABSTRACT

Cage (1) configured to house thereinside a friction ring to be used in friction dampers for washing machines, characterized in that it comprises a first (11) and a second piece (12) configured to be coupled by introducing the one in the other one.

### BACKGROUND OF THE INVENTION

### 1. Field of the Invention

The present invention relates to a cage for a friction ring to be used in friction dampers for washing machines.

### 2. Brief Description of the Prior Art

It is known the use of friction dampers in washing machines, which are constrained to drum and frame of washing machines to reduce noise and vibrations caused by electrical washing machines centrifuge.

All the known embodiments comprise an outer shell or casing, substantially tubular in shape, open at an end, a piston sliding inside said shell and one or more friction rings integrally mounted to a cage. The cage is introduced inside the shell and can slide axially with respect to the same between a first and a second position determined by suitable limit stops, and the piston is introduced inside the cage. A plug, installed at the open end of the shell, acts as limit stop for the cage and prevents the same from going out from the shell. Shell and piston are constrained to both elements (frame and drum of the washing machine) the damping action is destined to. In case of using an inner friction ring (or friction strip), i.e. constrained between cage and piston, the damper carries out its friction action when oscillations between frame and drum are such that the cage is displaced, which instead would move integrally with the piston until it reaches the stop position. In that position the cage is still while the piston, since it continues to slide, is slowed down by the friction exerted by the friction strip.

At the state of the art there are known many embodiments of friction dampers for washing machines functioning basically according to what just described. In document EP1286461 it is described a damper comprising a cage configured so that two friction strips are supported, an inner one (in contact to the pipe) and an outer one (in contact to the shell), and two spring limit stops (Belleville washer or compressible plugs) to limit the possible movement of the cage. Another embodiment is shown in document EP0806514, where it is described a friction damper for washing machines comprising a cage provided with a single friction strip, positioned inside (in contact to the piston) and two limit stops realized by means of two helical springs. Document EP1584730 describes a friction damper for washing machines comprising a cage provided with a single friction strip which can be both inner (in contact to the piston) and outer (in contact to the shell), and two limit stops realized by means of two helical springs, in addition to a closing plug provided with spring tongues. A variant is described in document EP1637640, wherein it is described a damper comprising a cage provided with a single inner friction strip (in contact to the piston) and two limit stops, configured to limit the axial movement of the cage, formed by plastic teeth provided on the plug and on the shell. These limit stops, even if rigid, are configured to act on the friction strip, and so, the whole functioning of the limit stop occurs anyway in spring mode, exploiting the deformability of the same strip. Document EP1754908 described a damper comprising a cage provided with a single friction strip obtained in the same piston. Document EP2406519 describes an embodiment with the same features described in EP1637640 and EP 1584730 and comprises further guides on cage and shell configured to limit rotation of the cage with respect to the shell.

Yet, in document US2015/020552 it is described a damper for washing machines in which the friction ring is held in position between shell (cylinder, 122 322 in document) and plug (restricting member 60). In this embodiment, during its movement relative to the friction ring, the piston slides with respect to the shell, but its end remains inside the same shell. Moreover, the friction ring is fixed to the shell of the damper.

As it is clear from the above analysis, all the embodiments known at the state of the art for friction dampers for washing machines use a cage for containing a friction ring (in some cases the friction rings used are two in number). Therefore, it is an extremely relevant element which, however, has never been significantly improved to allow easier assembling steps of the friction ring inside the cage, and to use the same cage for dampers intended to support different loads and which, so, need friction rings or strips of different size.

### SUMMARY OF THE INVENTION

Aim of the present invention is to provide a cage to be used with friction dampers for washing machines which makes easier the assembling steps, in comparison to the embodiments known at the state of the art, and which allows to use both friction rings obtained from polyurethane strips wound around the piston and friction rings shaped as innerly hollow cylinder.

Yet, the present invention provides a cage to be used in friction dampers for washing machines provided with a circular stop surface and without interruptions for the friction ring.

According to another aim, the present invention provides a cage for friction rings realized in two separated pieces which can be assembled by simply approaching them in axial direction.

Yet, according to another aim the present invention provides a cage for friction rings configured to be used together with friction rings and strips of different size, able to function correctly with different loads acting on the damper.

The invention reaches the prefixed aims since it is a cage configured to house thereinside a friction ring to be used in friction dampers for washing machines, characterized in that it comprises a first and a second piece configured to be coupled by introducing the one in the other one.

### BRIEF DESCRIPTION OF THE DRAWINGS

The invention will be now described in detail by means of some preferred embodiments, with reference to the appended FIGS. 1 to 7.

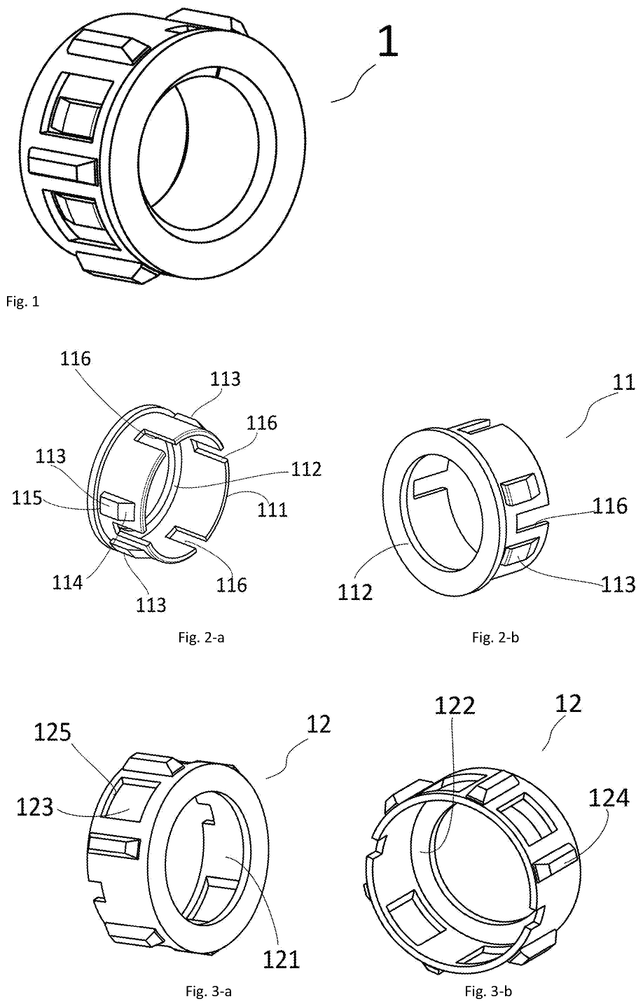

In FIG. 1 there is shown an axonometric view of a first embodiment of the cage, whose elements are shown disassembled in FIGS. 2a, 2b, 3a, 3b.

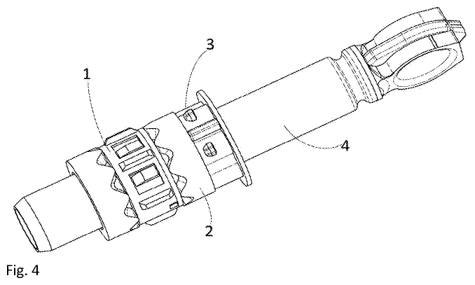

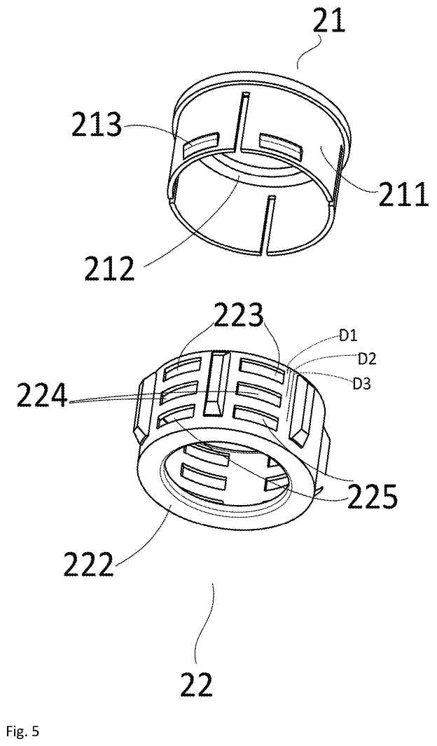

In FIG. 4 there is shown the same embodiment assembled on a piston. A second embodiment is shown in FIGS. 5 to 7.

### DETAILED DESCRIPTION OF THE PREFERRED EMBODIMENTS

With reference to FIG. 4, the cage (1) according to the invention is configured to house thereinside a friction ring (not shown in FIG. 4). It is shaped substantially as a cylinder and is hollow inside so that it can house slidingly a piston (4), on which there are shown installed also spring limit stops (2) and the closing plug (3) of the shell of the damper.

Moreover, the cage is configured so that the piston can project with respect to the same from both portions, as it is shown for example in the appended FIG. 4, so that it is possible to install spring limit stops (2) around the piston, from both portions of the cage. In this manner, the cage is movable both with respect to the piston (4) and with respect to the closing plug (3). Moreover, the cage is movable with respect to the shell as well (not shown in FIG. 4) of the damper.

Since the limit stops (2) limit the possibility of the cage (1) to slide with respect to the shell, their provision allows to define movement areas of the piston in which the cage (and so the friction ring) are integral to the piston (4), and movement areas of the piston in which there is relative movement between cage (and so friction ring) and piston (4). Obviously, the damping force is exerted only when there is relative movement between cage and piston.

The cage (1) is made up of two pieces (11, 12) shown in FIGS. 2 and 3, respectively, configured to be coupled by introducing the one in the other one.

The two pieces are shaped as a cylindrical crown provided at an end with an end stop. It is to be said that with axial direction it is intended the direction of the symmetrical axis of said pieces. In FIG. 2-a, where it is shown a portion (11) which in the coupling is inside, both the cylindrical wall (111) and the end stop (112) are shown. On the outer surface of the cylindrical wall (111) there are realized a plurality of projections (113) with wedge shape, the wedge point being oriented to the opposite portion with respect to said stop (112).

In FIG. 3 it is shown the portion (12) which in the coupling is outside. Both the cylindrical wall (121) and the end stop (122) are shown. On the cylindrical wall (121) of the outer piece (12) there are realized a plurality of holes—or housings (123), preferably in rectangular shape, spaced on the circumference so that they each are at a relative wedge projection (113).

The cylinder walls (111, 121) of the inner (11) and outer piece (12) of the cage (1) are configured so that they can be coupled with clearance, the outer radius of the cylinder wall (111) of the first piece (11) being slightly lower than the inner radius of the cylinder wall (121) of the outer piece (12).

The projections in wedge shape (113) are such that, by coupling the two pieces (11, 12) along the axial direction the point (114) of each wedge (113) is introduced firstly inside the cylinder wall (121) of the outer piece (12) and, after, deforms slightly and elastically the two cylinder walls (111, 121) until it is positioned, as shown in FIG. 1, inside its own housing (123). When the spring deformation of the two cylinder walls (111, 121) is ended the assembly of projections (113) is constrained to respective housings (123), and in particular the rear wall (115) of each wedge (113) strikes against the surface (125) facing outside of the respective housing (123). This occurs since, as it is shown in figures, the rear portions (115) of all the wedges (113) are aligned with each other at the same distance from the stop (112).

Before assembling the two pieces (11, 12) it is possible to introduce inside the first portion (11) a friction ring, realized in polyurethane or other material. The ring, once the cage (1) is assembled, is trapped between the two stops (112, 122) and cannot go out from its own seat unless it is deformed inwards, which is avoided by the piston (4) in the following introduced inside the cage (1). Obviously in case of using friction strips, the same can be introduced inside the cage (1), after it is assembled. Realizing the cage (1) in two pieces allows to obtain stop surfaces (112, 122) which have a circular inner edge and no interruptions, since each one of the two pieces does not have undercuts for realizing these surfaces.

Preferably, but not limitingly, the outer portion (12) has, on its outer surface (121), ribs (124) with the double function of stiffening the surface of the cage and of being used to limit the relative rotation between cage and shell of the damper. Moreover, preferably, on the cylinder wall (111) of the inner portion (11) there are realized open slots (116) which are used to reduce resistance to deformation of the same wall.

According to another embodiment shown in FIGS. 5, 6 and 7, the outer wall (22) of the cage can comprise a plurality of housings shaped as rectangular holes, distributed on the circumference, as yet described for the previous embodiment, and aligned on a plurality of outer circumferences at different distance from the stop (222). In other words, in the hypothesis that there are four wedges (213) on the inner portion (21), on the outer portion (22) there will be provided four housings (223) with the edge aligned at a distance (DI) from the end of the outer portion (22), four housings (224) with the edge aligned at a second distance (D2) from the end of the outer portion (22) and four housings (225) with the edge aligned at a third distance from the end of the outer portion (22).

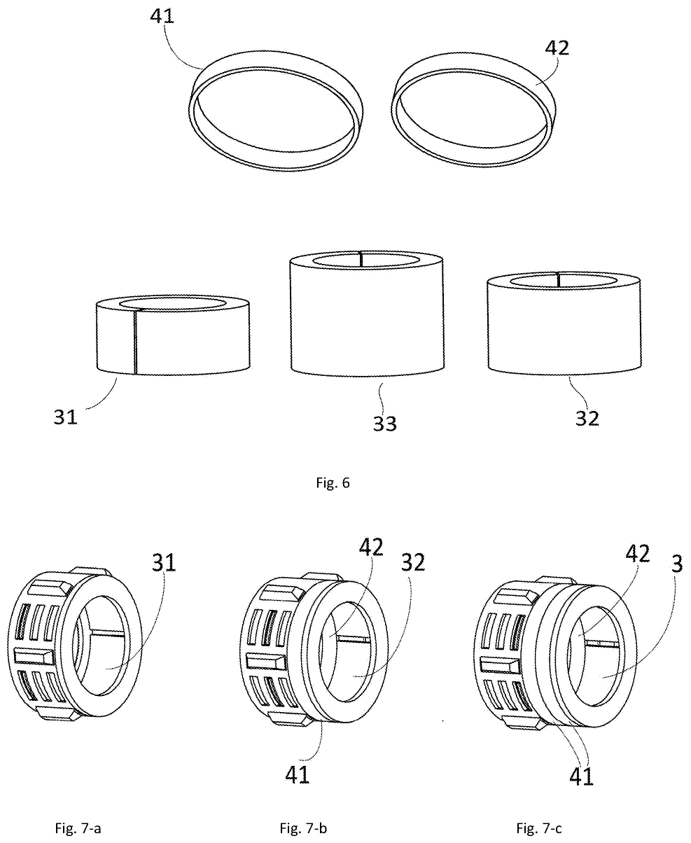

In this way, the corresponding wedges (213) provided on the cylinder surface (211) of the inner portion (21) can engage the first row of housings (223), the second (224) or the third one (225). Therefore, the length in axial direction comprised between the two stops (212, 222) is variable, and this allows to use friction rings of different height (31, 32, 33), shown in FIG. 6. The cages assembled with the rings with different height are shown in FIG. 7.

In case of using rings with such height that the inner portion is moved away from the outer one, there can be used inner (42) or outer (41) spacers. The use of an outer spacer (41) is shown in FIG. 7, where it is shown how one or more of these spacers can be used to lengthen the cylinder wall (221) of the outer portion until it strikes against the inner portion. The use of an inner spacer (42) is the same and it is used to lengthen the cylinder wall of the inner portion (21) until it strikes against the outer portion. Obviously, the inner spacer (42) is hidden from the view in FIG. 7, where the cage is shown assembled.

1. A cage (1) configured to house thereinside a friction ring to be used in friction dampers for washing machines, said cage (1) comprising a first piece (11) and a second piece (12) configured to be coupled by introducing said first piece (11) into said second piece (12), said cage (1) being substantially of cylindrical shape and is being provided with a through-hole inside which a piston (4) is housed slidingly.

2. The cage (1) according to claim 1, wherein on said piston (4), spring limit stops (2) can be installed from opposite portions with respect to said cage (1).

3. The cage (1) according to claim 1, wherein said first piece (11) and second piece (12) are each shaped as cylinder crowns and comprise each a cylinder wall (111, 121) provided at an end with an end stop (112, 122), said cylinder walls (111,121) being configured so that they can be coupled with clearance and said stop surfaces (112, 122) being provided with an inner edge of circular shape.

4. The cage (1) according to claim 3, wherein on that cylinder wall (111) outer surface of an inner portion, there are a plurality of projections (113) having a wedge shape, configured to engage a plurality of housings (123) realized on the cylinder wall (121) of an outer portion of said second piece (12).

5. The cage (1) according to claim 4, wherein said outer portion of said second piece (12) is provided, on its own outer surface (121), with ribs (124) configured so that the surface (121) of said outer portion of the cage is stiffened.

6. The cage (1) according to claim 3, wherein on the cylinder wall (111) of the inner portion (11) there are open slots (116) configured to reduce the resistance to the deformation of said wall (111).

7. The cage (1) according to claim 1, further comprising an outer portion (22) of the cage, said outer portion (22) comprises a plurality of housings shaped as rectangular holes, aligned on a plurality of outer circumferences at different distance from a stop (222).

8. The friction damper for washing machines, comprising a cage (1) of claim 1.
